(19) United States
(12) Patent Application Publication
(10) Pub. No.: US 2026/0128402 A1
(43) Pub. Date: May 7, 2026

(54) BATTERY MODULE AND BATTERY SYSTEM WITH TEMPERATURE CONTROL AND FIRE PROTECTION FUNCTIONS

(71) Applicant: ETI CA BATTERY INC., New Taipei City (TW)

(72) Inventor: Wei-Chen WU, New Taipei City (TW)

(73) Assignee: ETI CA BATTERY INC., New Taipei City (TW)

(21) Appl. No.: 19/013,806

(22) Filed: Jan. 8, 2025

(30) Foreign Application Priority Data
Nov. 4, 2024 (TW) 113142113

(51) Int. Cl. H01M 10/613; H01M 10/0525; H01M 10/6551; H01M 10/6568; H01M 50/204; H01M 50/645

(52) U.S. Cl. CPC H01M 10/613; H01M 10/0525; H01M 10/6551; H01M 10/6568; H01M 50/204; H01M 50/645

(57) ABSTRACT

A battery module and a battery system with temperature control and fire protection functions are provided. The battery module includes a battery tank, battery cells, and a water-cooling plate. The battery cells are arranged within the battery tank. The water-cooling plate covers the top of the battery tank. The bottom of the water-cooling plate is provided with heat conductors that respectively extend to gaps among the battery cells. The interior of the water-cooling plate is provided with a cooling channel. The bottom of the water-cooling plate is provided with an opening hole and a waterproof plug. The opening hole communicates with the cooling channel. The waterproof plug seals the opening hole. When high pressure or high heat detaches the waterproof plug from the opening hole or damages the waterproof plug, the cooling water in the cooling channel flows into the battery tank.

### BACKGROUND OF THE INVENTION

This application claims priority for the TW Application No. 113142113 filed on 4 Nov. 2024, the content of which is incorporated by reference in its entirely.

### FIELD OF THE INVENTION

The present invention relates to technology for cooling batteries, particularly to a battery module and a battery system with temperature control and fire protection functions.

### DESCRIPTION OF THE RELATED ART

Energy storage batteries require high capacity. Thus, a large number of battery cells are usually connected in series and parallel. However, the batteries are used to generate heat. To solve the temperature problem, cooling systems, such as air-cooling systems, water-cooling plates, or immersion cooling systems, are traditionally used to cool down the batteries. When the thermal runaway of a battery occurs, it is easy to cause spontaneous combustion. In addition, assembling multiple battery cells of the battery causes a chain reaction. It is not easy to extinguish the fire in a short time. However, the power supply on site is often interrupted by fire, causing the cooling system to fail. Thus, the cooling system cannot continue to cool the battery. In order to overcome the problem, other fire protection equipment such as sprinklers will be installed on site to spray the entire area and prevent the thermal runaway of a battery from affecting other areas. However, battery fires (especially lithium battery fires) are difficult to extinguish completely. Large amounts of water need to be endlessly sprayed, thereby fully controlling the fire. In addition to wasting water resources, toxic substances will flow with the water to other areas, causing serious pollution problems.

Therefore, the industry is currently in urgent need of seeking a battery module and a battery system with temperature control and fire protection functions to serve as an effective fire protection measure for thermal runaway batteries, so that the various difficulties and deficiencies encountered in the prior art can be overcome.

### SUMMARY OF THE INVENTION

The present invention provides a battery module and a battery system with temperature control and fire protection functions, which circulate the flow of cooling water in a water-cooling plate to help battery cells dissipate heat, thereby achieving the effect of controlling the temperature of the battery cells in a normal state. When the thermal runaway of the battery cell occurs, the cooling water in the water-cooling plate will flow to the battery cell, thereby achieving the fire extinguishing effect.

In order to achieve the foregoing objectives, the present invention provides a battery module with temperature control and fire protection functions. The battery module includes a battery tank, battery cells, and a water-cooling plate. The interior of the battery tank accommodates an insulated cooling liquid. The top of the battery tank has an opening. The battery cells are spaced in the battery tank and immersed in the insulated cooling liquid. The water-cooling plate is arranged on the top of the battery tank to cover the opening. The bottom of the water-cooling plate is provided with heat conductors that respectively extend to gaps among the battery cells. The interior of the water-cooling plate is provided with a cooling channel. The two opposite sides of the water-cooling plate are respectively provided with a water inlet and a water outlet. The water inlet and the water outlet communicate with the cooling channel. Cooling water flows into the cooling channel from the water inlet and then flows out from the water outlet, thereby completing the circulation of the cooling water. The bottom of the water-cooling plate is provided with an opening hole and a waterproof plug. The opening hole communicates with the cooling channel. The waterproof plug seals the opening hole. When high pressure or high heat detaches the waterproof plug from the opening hole or damages the waterproof plug to expose the opening hole, the cooling water in the cooling channel flows into the battery tank through the opening hole to cool down the battery tank.

In an embodiment of the present invention, the battery cells are lithium-ion battery cells.

In an embodiment of the present invention, the cooling water is deionized water or the mixture of deionized water and antifreeze.

In an embodiment of the present invention, the waterproof plug is a waterproof gasket or a sticker. The gasket or the sticker breaks due to high pressure or high temperature.

The present invention also provides a battery system, which includes a plurality of the battery modules, a water inlet pipe, and a water outlet pipe. The battery modules are stacked from bottom to top. The openings of the battery tanks face toward the same direction. The water inlet pipe is arranged outside the battery modules, connected with the water inlets of the water-cooling plates, and configured to transmit the cooling water to the water inlets. The water outlet pipe is arranged outside the battery modules, connected with the water outlets of the water-cooling plates, and configured to receive the cooling water from the water outlets.

In an embodiment of the present invention, the battery system further includes a pump arranged outside the battery modules and connected with the water outlet pipe or the water inlet pipe. The pump is configured to drive the cooling water to complete the circulation of the cooling water.

In an embodiment of the present invention, the battery system further includes a main water box arranged above the battery modules. The main water box accommodates the cooling water. The two opposite sides of the main water box are respectively connected with the water outlet pipe and the water inlet pipe.

In an embodiment of the present invention, the battery system further includes a heat exchanger connected to the main water box and configured to cool the cooling water in the main water box.

In an embodiment of the present invention, the main water box is further provided with a reliever that communicates with the inner space of the main water box. The reliever is configured to adjust the pressure of the inner space to be lower than or equal to a given pressure.

In an embodiment of the present invention, the main water box is further provided with a gas filtering device arranged in the inner space of the main water box and configured to absorb toxic substances and flammable gases in the inner space.

Compared to the conventional technology, the present invention has the following advantages:
1. The battery module and the battery system with temperature control and fire protection functions of the present invention employ the specially designed water-cooling plate that can continuously dissipate heat from the battery cells. When the thermal runaway of the battery cell occurs, the cooling water inside the water-cooling plate will flow to the battery cell, thereby cooling its temperature and achieving the effect of extinguishing the fire.
2. The battery module and the battery system with temperature control and fire protection functions of the present invention can automatically achieve the fire protection effect without any electricity. As long as the battery cells generates high-pressure gas or the batteries burn, the cooling water in the water-cooling plate will automatically flows into the battery tank to cool down the battery cells.
3. In the battery module and the battery system with temperature control and fire protection functions of the present invention, the path for discharging toxic gas generated by the thermal runaway of the battery cells is filled with the cooling water, such that the toxic gas will be dissolved in the cooling water to significantly reduce the toxicity of the discharged gas.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a battery module with temperature control and fire protection functions according to an embodiment of the present invention;

FIG. 2 is a schematic diagram illustrating the operation state of a battery module with temperature control and fire protection functions when battery cells are on fire according to an embodiment of the present invention;

FIG. 3 is a schematic diagram illustrating a battery system according to an embodiment of the present invention;

FIG. 4 is a schematic diagram illustrating the operation state of a battery system when battery cells are on fire according to an embodiment of the present invention; and

FIG. 5 is a schematic diagram illustrating a battery system according to another embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

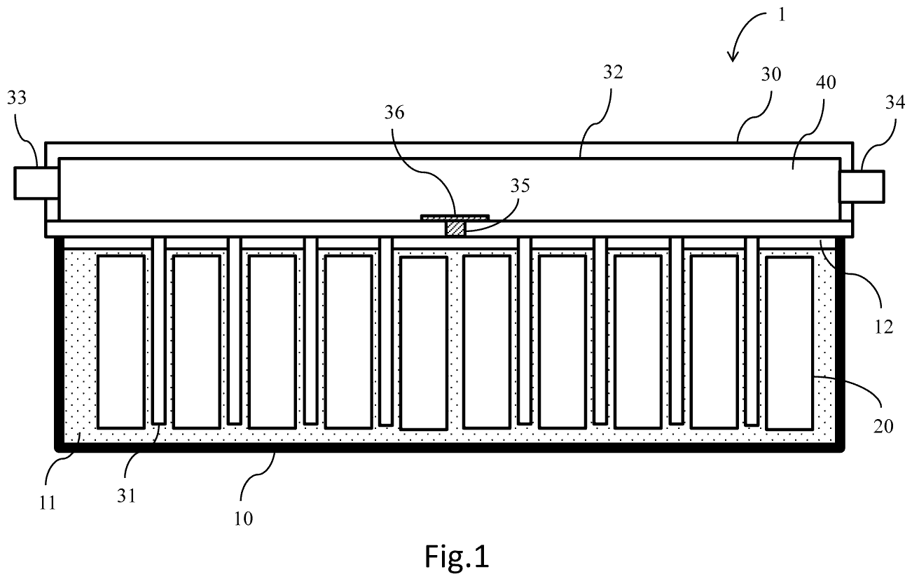

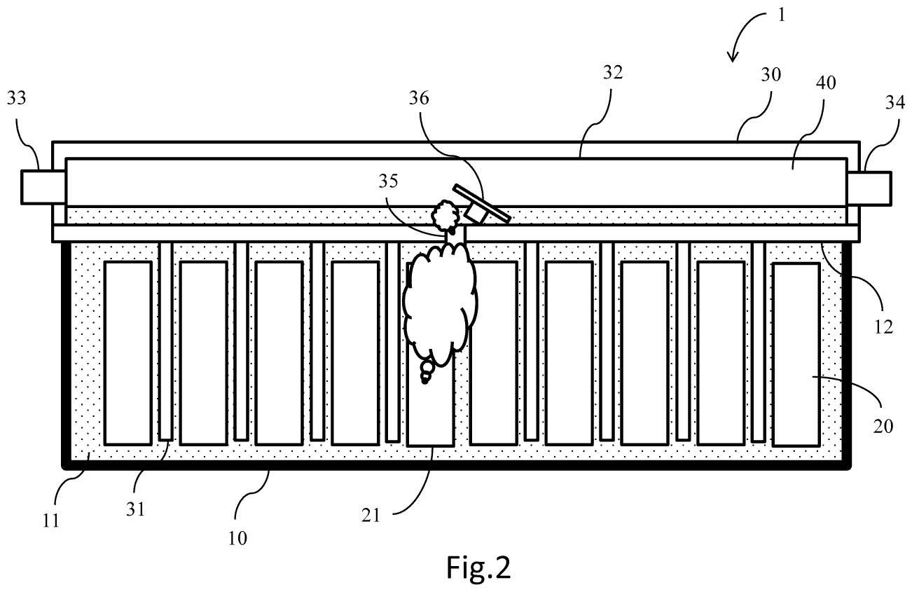

Please refer to FIG. 1 and FIG. 2. FIG. 1 is a schematic diagram illustrating a battery module with temperature control and fire protection functions according to an embodiment of the present invention. FIG. 2 is a schematic diagram illustrating the operation state of a battery module with temperature control and fire protection functions when battery cells are on fire according to an embodiment of the present invention. In the embodiment, a battery module 1 mainly includes a battery tank 10, battery cells 20, and a water-cooling plate 30.

The interior of the battery tank 10 accommodates an insulated cooling liquid 11. The top of the battery tank 10 has an opening 12.

The battery cells 20 are spaced in the battery tank 10 and immersed in the insulated cooling liquid 11. In the embodiment, the battery cells 20 may be, for example, lithium-ion battery cells.

The water-cooling plate 30 is arranged on the top of the battery tank 10 to cover the opening 12. A closed space is formed between the water-cooling plate 30 and the battery tank 10. The bottom of the water-cooling plate 30 is provided with heat conductors 31. The heat conductors 31 may be heat conducting plates or heat conducting columns. The heat conductors 31 respectively extend to gaps among the battery cells 20 such that heat generated by the battery cells 20 can be dissipated to the heat conductors 31 through the insulated cooling liquid 11 in the battery tank 10. Thus, the heat conductors 31 can take away the heat. The interior of the water-cooling plate 30 is provided with a cooling channel 32. The two opposite sides of the water-cooling plate 30 are respectively provided with a water inlet 33 and a water outlet 34. The water inlet 33 and the water outlet 34 communicate with the cooling channel 32. The water inlet 33 receives the cooling water 40. Accordingly, the cooling water 40 flows into the cooling channel 32 from the water inlet 33 and then flows out from the water outlet 34, thereby completing the circulation of the cooling water 40 to help heat dissipation. In addition, the bottom of the water-cooling plate 30 is provided with an opening hole 35 and a waterproof plug 36. The opening hole 35 communicates with the cooling channel 32. The waterproof plug 36 seals the opening hole 35. When high pressure or high heat detaches the waterproof plug 36 from the opening hole 35 or damages the waterproof plug 36 to expose the opening 35, the cooling water 40 in the cooling channel 32 flows into the battery tank 10 through the exposed opening hole 35 to cool down the battery tank 10.

In the embodiment of the present invention, the density of the cooling water 40 is greater than that of the insulated cooling liquid 11. The insulated cooling liquid 11 may include mineral oil, silicone oil, synthetic oil, engineering fluids, and polyol ester. Specifically, the cooling water 40 may be, for example, deionized water or the mixture of deionized water and antifreeze. In the embodiment of the present invention, the waterproof plug 36 is a waterproof gasket or a sticker. The gasket or the sticker can break due to high pressure or high temperature. When the battery tank 10 has a temperature greater than a given temperature or has a pressure greater than a given pressure, the gasket or the sticker automatically breaks such that the cooling water 40 in the water-cooling plate 30 flows into the battery tank 10.

As illustrated in FIG. 1, the battery tank 10 is filled with the insulated cooling liquid 11, so that the heat dissipated by the battery cells 20 can be conducted to the heat conductor 31 under the water-cooling plate 30 through the insulated cooling liquid 11, thereby transferring the heat to the water-cooling plate 30. The cooling water 40 circulates in the water-cooling plate 30 to continuously discharge heat to the outside of the battery module 1, thereby achieving a sufficient heat dissipation effect. The waterproof plug 36 on the bottom of the water-cooling plate 30 will seal the opening 35 in a normal state. The cooling water 40 in the water-cooling plate 30 will not flow into the battery tank 10 under the water-cooling plate 30. As illustrated in FIG. 2, when the thermal runaway of a battery cell 21 of the battery cells 20 occurs, the battery cell 21 will generate high heat and high pressure gas. As a result, the waterproof plug 36 will be ejected upward due to the high pressure generated by the gas in the battery cell 21 or melted due to the high heat, thereby exposing the opening 35. Simultaneously, the cooling water 40 in the water-cooling plate 30 will flow into the battery tank 10 through the opening 35 to cool down the entire battery tank 10.

In the embodiment of the present invention, the density of the cooling water 40 is greater than that of the insulated cooling liquid 11, so that the cooling water 40 will stay in the lower half of the battery tank 10, and the insulated cooling liquid 11 will float in the upper half of the battery tank 10. At this time, the cooling water 40 can have a fire protection effect and a cooling effect on the battery module 1.

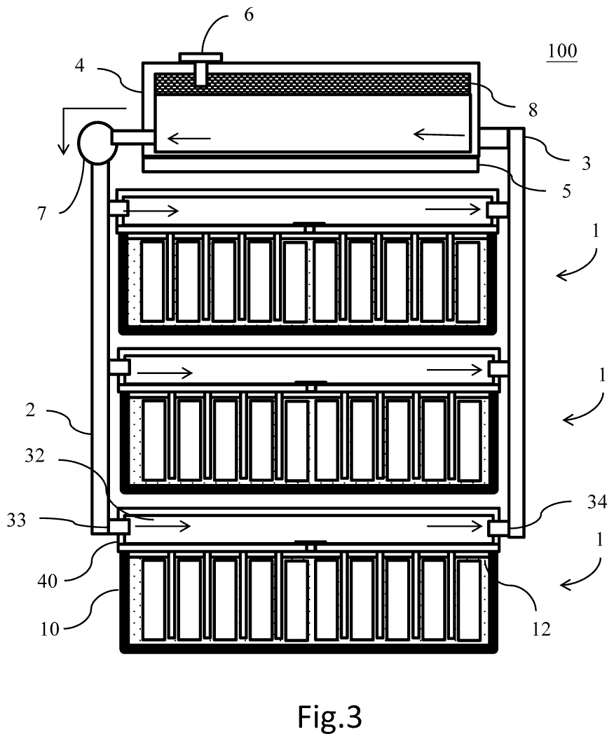

The battery module with temperature control and fire protection functions of the present invention can be also applied to a large storage energy battery. Please refer to FIG. 3. FIG. 3 is a schematic diagram illustrating a battery system according to an embodiment of the present invention. In the embodiment, a battery system 100 includes the plurality of battery modules 1 of the foregoing embodiment, a water inlet pipe 2, and a water outlet pipe 3.

The openings 12 of the battery tanks 10 of the battery modules 1 face upward. The battery modules 1 are stacked from bottom to top in a vertical direction. The water inlet pipe 2 is arranged outside the battery modules 1 and connected with the water inlets 33 of the water-cooling plates 40. The water inlet pipe 2 transmits the cooling water 40 to the water inlets 33. The cooling water 40 can enter into the cooling channel 32 of the water-cooling plate 30 such that the cooling water 40 is cooled down. The water outlet pipe 3 is arranged outside the battery modules 1 and connected with the water outlets 34 of the water-cooling plates 30. The water outlet pipe 3 receives the cooling water 40 from the water outlets 34.

In the embodiment of the present invention, the battery system 100 further includes a main water box 4 arranged above all the battery modules 1. The main water box 4 accommodates the cooling water 40 provided to all the battery modules 1. The two opposite sides of the main water box 4 are respectively connected with the water outlet pipe 3 and the water inlet pipe 2. In addition, the main water box 4 is provided with a heat exchanger 5 such as air-cooled or other temperature control equipment. The heat exchanger 5 is used to control the temperature of the cooling water 40 in the main water box 4. The main water box 4 is further provided with a reliever 6 that communicates with the inner space of the main water box 4. When the pressure of the inner space of the main water box 4 is greater than a given pressure, the reliever 6 is turned on to relieve the pressure of the inner space.

Besides, the battery system 100 in the embodiment of the present invention can further include one or more pumps 7 arranged outside the battery modules 1 and connected with the water outlet pipe 3 or the water inlet pipe 2. By driving the cooling water 40 under pressure, the circulation flow of the cooling water 40 can be accelerated and the heat dissipation effect of the water cooling plate 30 can be improved. For simplicity and clarity, in the embodiment of the present invention, only one pump 7 is connected to the water inlet pipe 2. The pump 7 will pressurize and drive the cooling water 40 in the main water tank 4 into the water-cooling plate 30 above each battery module 1. The water-cooling plates 30 cool down all the battery modules 1. In addition, the upper inner space of the main water tank 4 is provided with a gas filtering device 8. The filter material of the gas filtering device 8 can be an activated carbon adsorbent material or a molecular sieve adsorbent. The molecular sieve adsorbent may be, for example, zeolite. When the gas in the battery system 100 has too large pressure, the gas is discharged from the main water box 4 through the gas filtering device 8, and the gas filtering device 8 absorbs toxic substances and flammable gases.

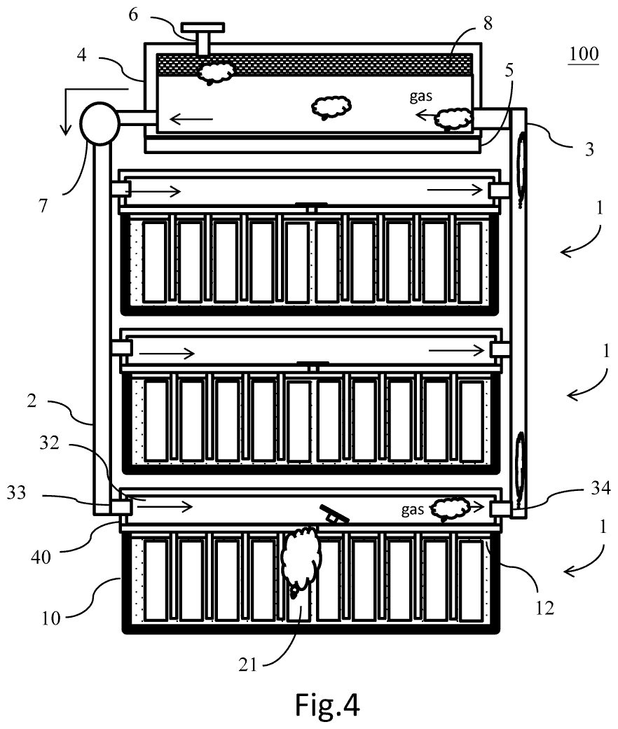

Please refer to FIG. 4. FIG. 4 is a schematic diagram illustrating the operation state of a battery system 100 when battery cells are on fire according to an embodiment of the present invention. When the thermal runaway of the battery cell 21 occurs, the high-pressure and high-heat gas generated by the battery cell 21 will firstly rush into the cooling channel 32 of the water-cooling plate 30 above the battery tank 10. The gas will rush into the main water box through the water outlet pipe 3. The reliever 6 on the main water box 4 is turned on to discharge the high-pressure gas. Because the path for discharging the foregoing toxic gas is filled with the cooling water 40, the toxic gas generated by the battery cell 21 will firstly be dissolved in the cooling water 40, which can greatly reduce the chance of discharging the toxic gas to the air. In addition, the gas filtering device on the main water box 4 not only absorbs toxic gases but also absorbs flammable gases such as methylpropane, etc., greatly reducing the chance of discharging flammable gases to the outside. In addition to the cooling effect in a normal state, the cooling water 40 in the main water box 4 has fire protection functions.

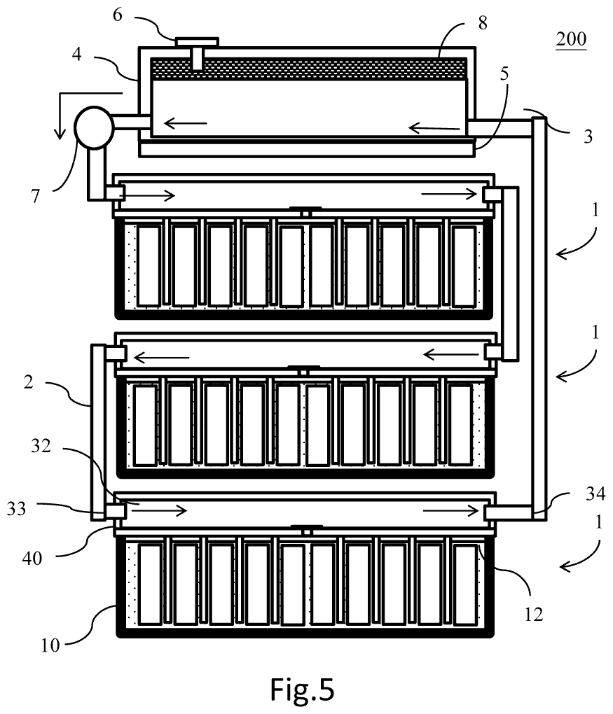

In the embodiment of the present invention, when the battery modules 1 are stacked, the water-cooling plates 30 of the battery modules 1 can be connected in parallel, as illustrated in the battery system 100 of FIG. 3. Alternatively, as illustrated in the battery system 100 of FIG. 5, In the battery system 200 shown, the water-cooling plates 30 of the battery modules 1 can also be connected in series when the battery modules 1 are stacked.

In conclusion, the battery module and the battery system with temperature control and fire protection functions of the present invention employ the specially designed water-cooling plate that can continuously dissipate heat from the battery cells. When the thermal runaway of the battery cell occurs, the cooling water inside the water-cooling plate will flow to the battery cell, thereby cooling its temperature and achieving the effect of extinguishing the fire.

On top of that, the battery module and the battery system with temperature control and fire protection functions of the present invention can automatically achieve the fire protection effect without any electricity. As long as the battery cells generates high-pressure gas or the batteries burn, the cooling water in the water-cooling plate will automatically flows into the battery tank to cool down the battery cells. Thus, there is no need to worry about the failure of the cooling system. In the battery module and the battery system with temperature control and fire protection functions of the present invention, the path for discharging toxic gas generated by the thermal runaway of the battery cell is filled with the cooling water, such that the toxic gas will be dissolved in the cooling water to significantly reduce the toxicity of the discharged gas and reduce the risk of contamination.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A battery module with temperature control and fire protection functions, comprising:
a battery tank with an interior thereof accommodating an insulated cooling liquid and a top thereof having an opening;
battery cells spaced in the battery tank and immersed in the insulated cooling liquid; and
a water-cooling plate arranged on the top of the battery tank to cover the opening, wherein a bottom of the water-cooling plate is provided with heat conductors that respectively extend to gaps among the battery cells, an interior of the water-cooling plate is provided with a cooling channel, two opposite sides of the water-cooling plate are respectively provided with a water inlet and a water outlet, the water inlet and the water outlet communicate with the cooling channel, cooling water flows into the cooling channel from the water inlet and then flows out from the water outlet, thereby completing circulation of the cooling water, the bottom of the water-cooling plate is provided with an opening hole and a waterproof plug, the opening hole communicates with the cooling channel, the waterproof plug seals the opening hole, and when high pressure or high heat detaches the waterproof plug from the opening hole or damages the waterproof plug to expose the opening hole, the cooling water in the cooling channel flows into the battery tank through the opening hole to cool down the battery tank.

2. The battery module with temperature control and fire protection functions according to claim 1, wherein the battery cells are lithium-ion battery cells.

3. The battery module with temperature control and fire protection functions according to claim 1, wherein the cooling water is deionized water or a mixture of deionized water and antifreeze.

4. The battery module with temperature control and fire protection functions according to claim 1, wherein the waterproof plug is a waterproof gasket or sticker, and the gasket or the sticker breaks due to high pressure or high temperature.

5. The battery module with temperature control and fire protection functions according to claim 1, wherein a density of the cooling water is higher than that of the insulated cooling liquid.

6. A battery system comprising:
a plurality of the battery modules of claim 1 stacked from bottom to top, wherein the openings of the battery tanks face toward the same direction;
a water inlet pipe arranged outside the battery modules, connected with the water inlets of the water-cooling plates, and configured to transmit the cooling water to the water inlets; and
a water outlet pipe arranged outside the battery modules, connected with the water outlets of the water-cooling plates, and configured to receive the cooling water from the water outlets.

7. The battery system according to claim 6, further comprising a pump arranged outside the battery modules and connected with the water outlet pipe or the water inlet pipe, wherein the pump is configured to drive the cooling water to complete circulation of the cooling water.

8. The battery system according to claim 6, further comprising a main water box arranged above the battery modules, the main water box accommodates the cooling water, and two opposite sides of the main water box are respectively connected with the water outlet pipe and the water inlet pipe.

9. The battery system according to claim 8, further comprising a heat exchanger connected to the main water box and configured to cool the cooling water in the main water box.

10. The battery system according to claim 8, wherein the main water box is further provided with a reliever that communicates with an inner space of the main water box, and the reliever is configured to adjust pressure of the inner space to be lower than or equal to a given pressure.

11. The battery system according to claim 8, wherein the main water box is further provided with a gas filtering device arranged in an inner space of the main water box and configured to absorb toxic substances and flammable gases in the inner space.
